(19) United States
(12) Patent Application Publication
(10) Pub. No.: US 2003/0017740 A1
(43) Pub. Date: Jan. 23, 2003

(54) Electrical connector

(76) Inventor: Satoshi Watanabe, Tokyo (JP)

Correspondence Address: KANESAKA & TAKEUCHI, 1423 Powhatan Street, Alexandria, VA, 22314, US

(21) Appl. No.: 10/194,047

(22) Filed: Jul. 15, 2002

(30) Foreign Application Priority Data
Jul. 19, 2001 (JP) 2001-219980

(51) Int. Cl. H01R 4/24; H01R 4/26; H01R 11/20

(52) U.S. Cl. 439/393

(57) ABSTRACT

An electrical connector (20) comprises a movable member (30) movably supported by a housing (21) or terminals (22) and an arranging block member (10) plugged in the housing and having cable apertures (11) for accommodating a cables (C) such that the cables are disposed at a position corresponding to the position of a contact portion of the terminals. The cable in the cable aperture is press-connected with the contact portion by the movable member when the movable member moves to a predetermined position.

### BACKGROUND OF THE INVENTION

1. Field of the Invention

The present invention relates to an electrical connector for press-connecting a cable with a contact portion of a terminal by rotating a movable member.

2. Related Art

Such a connector is described, for example, in Japanese Kokai No. 11-345640. This conventional connector is used for a flat cable which has a plurality of cables arranged in a sheet-like fashion. The connector has a plurality of terminals, each having a flexible arm including a contact projection which is provided at an end of the flexible arm and disposed in the vicinity of an opening of the housing. The cable is inserted and disposed at a position corresponding to that of the contact projection. A movable member is supported by the housing and rotatable between open and closed positions. When the movable member is rotated to the closed position, it presses the cable against the contact projection so that contact projection penetrates an outer cover of the cable and press-connects with a core wire of the cable. All the cables of the flat cable are simultaneously press-connected by the rotation of the movable member. The conventional connector has a good press-connection for the flat cable.

However, when it comes to a multiple-cable with a plurality of cables disjoined from each other or a flat cable having a plurality of cables separated from each other at its end, each cable is not supported to stay at a definite place and lies at random. Thus, it is difficult to secure each cable at the position for press-connection.

### SUMMARY OF THE INVENTION

Accordingly, it is an object of the invention to provide an electrical connector capable of firmly securing a cable at the position for press-connection.

According to the invention there is provided an electrical connector that comprises a housing having an opening and a receiving portion provided at the opening, a plurality of terminals arranged in the housing at a fixed interval, each having a flexible arm including a contact portion, and the contact portion projecting through the opening, and a movable member movably supported by the housing or the terminals at the opening.

The connector further comprises an arranging block member plugged in the receiving portion of the housing and having cable apertures for accommodating the cables such that each cables is disposed at a position corresponding to the position of the contact portion, the cable aperture permitting the flexible arm to enter a lower part of the cable aperture so that the cable in the cable aperture is press-connected with the contact portion of the flexible arm by the movable member when the movable member moves to a predetermined position.

According to the invention, the cable is lightly held on the edges of the cable aperture of the arranging block member such that the cable is disposed at the upper edges of the cable aperture. The arranging block member is inserted into the receiving portion of the housing before the movable member is attached to the housing or when the movable member stays at the open position. At this point, the contact portion of the terminal enters the lower part of the cable aperture of the arranging block member. That is, the cable is sandwiched between the contact portion and a press portion of the movable member. Then the movable member is moved to the predetermined position, for example, rotated to the closed position to press the cable into the cable aperture and press it against the contact portion. The contact portion penetrates the outer cover of the cable and contact with a core wire of the cable. Thus, press-connection is completed.

According to another aspect of the invention, the movable member is rotatably supported by the housing or the terminals and the cable is press-connected with the contact portion when the movable member rotates to the closed position.

According to still another aspect of the invention, the cable apertures extend up to a position deeper than the position of the contact portion.

According to yet another aspect of the invention, the arranging block member comprises guiding apertures provided on the opposite side of the housing and communicates with the cable apertures. The cable is easily arranged in the cable aperture by providing the entry aperture portion.

According to another aspect of the invention, each of the guiding apertures has an aperture width equal to or larger than that of the cable apertures. It is because that although the cable aperture has preferably an aperture width corresponding to the diameter of the cable, the entry aperture portion is provided to guide the entry of the cable. Also, the thick entry aperture portion permits a thick cable to enter. In this case, the thick cable is inserted into the cable aperture by connecting it to a member having a proper width.

According to still anther aspect of the invention, each of the cable apertures has a deep aperture portion on the side of the housing and a shallow aperture portion on the opposite side of the housing so that the flexible arm of the terminal enters a lower part of the deep aperture portion.

According to yet another aspect of the invention, the cable apertures are provided on both sides of the arranging block member, and the movable member and the terminals are provided on both sides of the housing. In case of a pair wire, each wire is separated and arranged in the upper and lower cable apertures. It is preferable that the arranging block member has a portion tapered in a thichnesswise direction thereof in the range of the guiding apertures so that the distance between the separated cables of the pair wire is increased gradually, making the cable smoothly guided.

### BRIEF DESCRIPTION OF THE DRAWINGS

FIG. 1 is a perspective view of an arranging block member according to an embodiment of the invention.

FIG. 2 is a sectional view of the arranging block member with a cable accommodated therein.

FIG. 3 is sectional view of a connector according to the embodiment.

FIG. 4 is a sectional view of the connector with the arranging block member plugged therein.

FIG. 5 is a sectional view of the connector of FIG. 4, to which a movable member is attached.

FIG. 6 is a section view of the connector of FIG. 5, wherein the press-connection is completed at the closed position of the movable member.

FIG. 7(A) is a sectional view of the arranging block member according to another embodiment, wherein a thin shield wire is mixed into ordinary cables.

FIG. 7(B) is a sectional view of the arranging block member according to still another embodiment, wherein a thick cable is mixed into ordinary cables.

### DESCRIPTION OF THE PREFERRED EMBODIMENTS

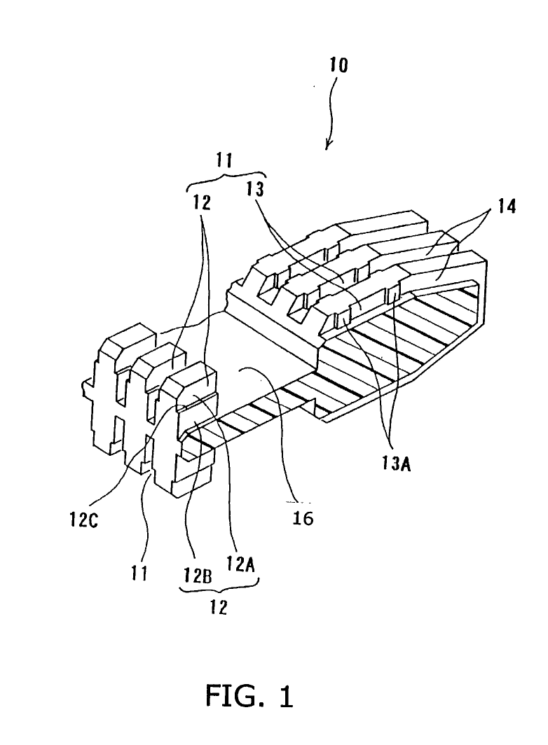

In FIG. 1, the arranging block member 10 is made of an insulative material, such as a plastic, and comprises cable apertures 11 in upper and lower faces thereof extending straight at an interval corresponding to the interval that terminals of the connector are arranged. The upper and lower cable apertures are formed in symmetry, and only the upper cable apertures 11 are described hereafter. The cable aperture 11 has a deep aperture portion 12 at the front end thereof and a shallow aperture portion 13 at the rear end thereof. A recess 16 is provided between the deep and shallow portions such that it communicates with a plurality of the cable apertures 11. The depth of the recess 14 is equal to that of the deep aperture portion 12.

The deep aperture portion 12 comprises a stepped portion 12C at the middle thereof in the depthwise direction. An upper aperture section 12A is provided at a position above the stepped portion 12C with an aperture width substantially equal to or a little smaller than the diameter of the cable such that the cable is lightly press-fitted therein. A lower aperture section 12B is provided at a position below the stepped portion 12C with an aperture width smaller than the diameter of the cable so as to prevent the entry of the cable. The stepped portion 12C may be replaced with a tapered portion, wherein the aperture width is gradually reduced from the upper aperture section 12A to the lower aperture section 12B. Otherwise, the stepped portion may be omitted and the entire aperture has a uniform aperture width which is a little smaller than the diameter of the cable. The depth of the upper aperture section 12A, that is, the distance from the upper edge of the upper aperture section 12A to the stepped portion 12C, is preferably equal to the diameter of the cable.

The shallow aperture portion 13 has a depth substantially equal to that of the upper aperture section 12A and a width substantially equal to the diameter of the cable. A projection 13A projects a little from the inside surface of the shallow aperture portion 13. The cable is press-fitted and held by the projection 13A of the shallow aperture portion and the upper aperture section of the deep aperture portion 12.

Guiding apertures 14 are provided at a tapered part behind the shallow aperture portion 13 and extend rearwardly from the rear end of the shallow aperture portion 13. In FIG. 1, the guiding apertures 14 has an aperture width and depth which are equal to those of the shallow aperture portion 12, but may be made greater than them.

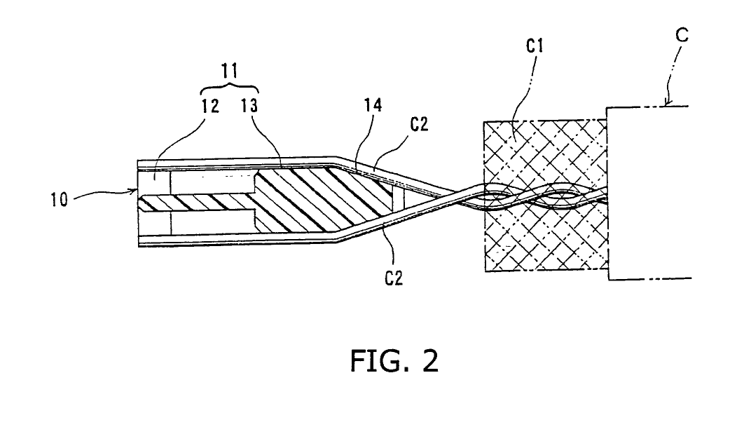

In FIG. 2, a cable C2 of a multi-wire cable, such as a coaxial cable C, is press-fitted in the guiding aperture 14, shallow aperture portion 13, and deep aperture portion 12 in this order after an outer cover of the cable C and an outer cover of a shield wire C1 are removed at the end portions thereof by a predetermined length. The cable C2 is press-fitted by putting it at aperture edges and then pressing it into the inside of the aperture. In FIG. 2, a pair of the cable C2 are arranged in the upper and lower apertures. All pairs of the cables C2 are arranged in the same way. In the range of the deep aperture portion 12, the cable C2 is laid in the upper aperture section 12A provided above the stepped portion 12C and there is a space in the lower aperture section 12B where no cable is present. In the range of the shallow aperture portion 13, the cable C2 is held by the projection 13A.

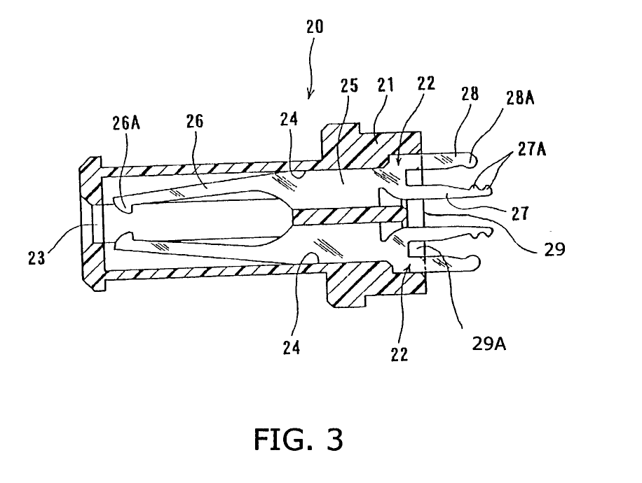

In FIG. 3, a connector 20 comprises a housing 21 and a plurality of terminals 22 provided in the housing 21. The housing 21 is vertically symmetrical, and the terminals 22 are also arranged in a vertically symmetrical fashion. The housing 21 has a cavity 23 at the left-hand side thereof, into which a mating connector (not shown) is plugged. A plurality of terminal accommodating slits 24 extending in parallel to the paper sheet are provided at the back of the cavity 23 at a predetermined interval in a vertically symmetrical fashion and in a direction perpendicular to the paper sheet. The predetermined interval of the terminal accommodating slits 24 is equal to that of the cable apertures of the arranging block member 10. The terminal accommodating slits 24 communicates with an opening 29 at the rear end of the housing 21 and the cavity 23 at the front side of the housing 21. A receiving portion 29A for receiving the front end of the arranging block member 10 is provided in the opening 29.

The terminals 22 are made by stamping a metal sheet. Each terminal 22 comprises a fixed portion 25 press-held in the terminal accommodating slits 24, a resilient arm 26 extending forwardly from the fixed portion 25 and having a connection portion 26a at the front end thereof, a flexible arm 27 extending rearwardly from the fixed portion 25, a pair of blade-shaped contact portions 27A provided at the rear end of the flexible arm 26 and functioning as a contact, a supporting arm 28 extending rearwardly and opposed to the flexible arm portion 27 and having a fulcrum 28A of a semi-circular shape at the end thereof. The resilient and flexible arms 26 and 27 are both flexible and deformable in a plane parallel to the paper sheet. The contact portions 27A and the fulcrum 28A project rearwardly from the housing 21.

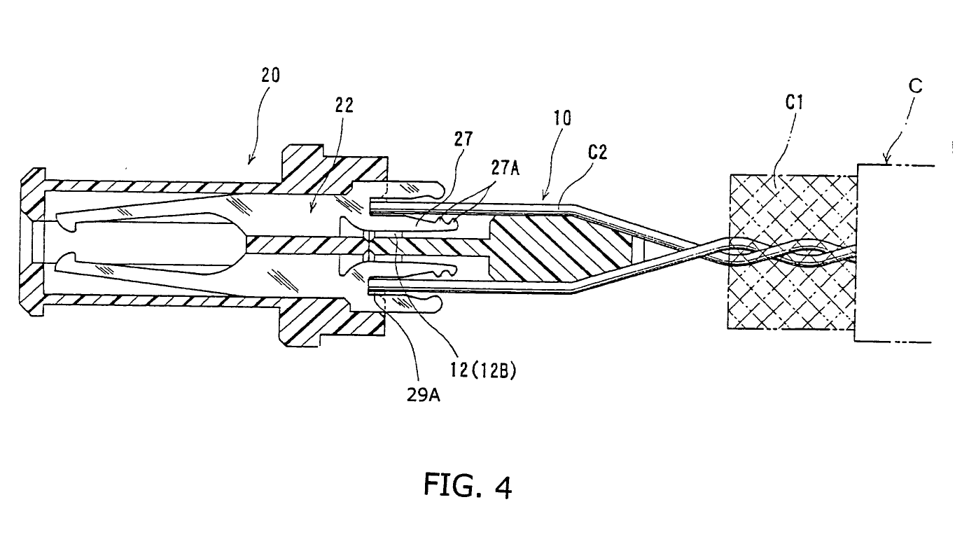

In FIG. 4, the arranging block member 10 with the cable C2 is received and held by the receiving portion 29 of the connector 20. At this point, the flexible arm 27 of the terminal 22 enters the lower aperture section 12B of the deep aperture portion 12, that is, the space provided under the cable C2 inserted into the upper aperture section 12A.

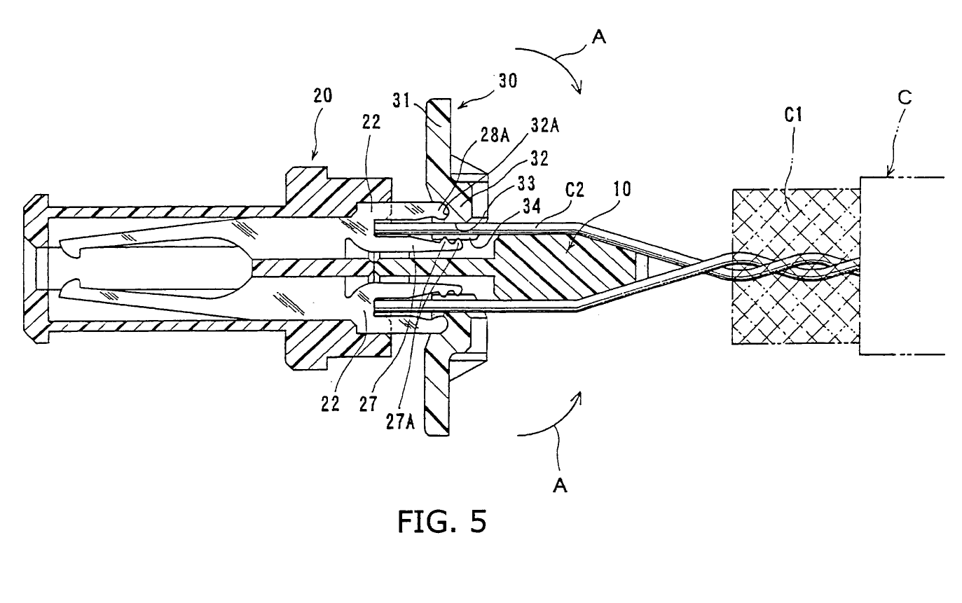

In FIG. 5, a movable member 30 is fixed to the connector 20 and extends in a direction perpendicular to the paper sheet. The movable member 30 comprises a handling lever 31 for rotating operation and a supported portion 32 having a semi-circular concave face 32A rotatably supported by the fulcrums 28A. The handling lever 31 rotates between the open position where it stands upright and the closed position where it lies horizontally after rotating around the fulcrum 28A in direction of arrow A. The movable member 30 further comprises a cable guiding aperture 33 at a position opposed to the contact portions 27A of the terminal 22 at the open position, and a terminal guiding slit 35 that communicates with the cable guiding aperture 33 and receives the contact portions 27A therein. Accordingly, the cable guiding aperture 33 accommodates the cable C2 at the position of the recess 16 of the arranging block member 10 when the movable member 30 is fixed to the housing 20 at the open position. A pair of the movable members 30 are rotatably supported in the upper and lower terminal rows in a symmetrical fashion.

How to assemble the connector will be described bellow.

(1) As shown in FIG. 2, the end portion of the outer cover of the multi-wire cable C is removed by a predetermined length. Thus, in the case of a coaxial cable, the shield wire C1 and a pair of wires are exposed. A twisted cables C2 of the pair wire are made straight at the end portion thereof (in FIG. 2, only one pair of cables are illustrated).

(2) Each of the cables C2 is inserted into the deep and shallow aperture portions 12, 13 of the arranging block member 10. The insertion is done by guiding the cable C2 to the guiding aperture 14 such that it is disposed along the edges of the shallow aperture portion 13 and pressing it into the shallow aperture portion 13, then inserting it into the upper aperture section 12A of the deep aperture portion 12. Thus, the cable C2 is press-fitted in the upper aperture section 12A of the deep aperture portion 12, and the projection 13A of the shallow aperture portion 13 prevents it from coming off. In this way, all cables C2 are arranged at the fixed interval.

(3) As shown in FIG. 4, the arranging block member 10 with cables C2 is assembled in the connector 20. The assembly is done by plugging the front end of the arranging block member 10 into the receiving portion 29 of the housing 21. The flexible arm 27 of the terminal 22 enters the lower aperture section 12B of the arranging block member 10 so that the contact portion 27A of the flexible arm 27 stays near the cable C2.

(4) Then, in FIG. 5, the movable member 30 is attached to the fulcrum 28A of the terminal 22 in the open position. The movable member 30 is accommodated in the cable guiding aperture 33 together with the cable C2, and the contact portion 27A is accommodated in the terminal guiding aperture 34.

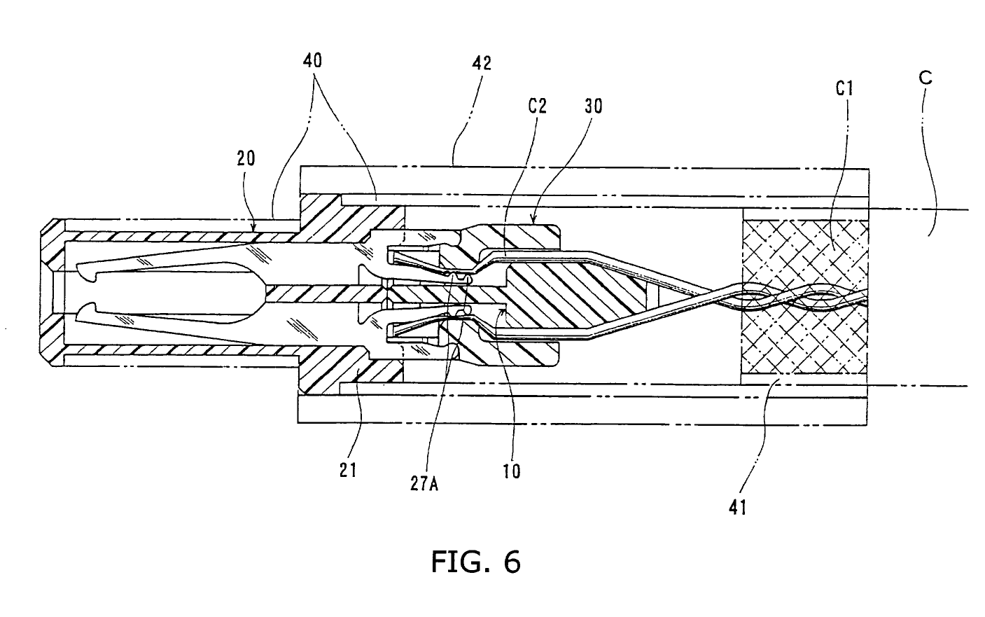

(5) Then, the movable member 30 is rotated in the direction of arrow A to the closed position. The cable C2 is pressed against the blade-shaped contact portions 27A by the press section of the movable member 30 so that the contact portions 27A penetrates the cover of the cable C2 and contacts with the core wire (not shown). Thus, as shown in FIG. 6, the terminal 22 is electrically connected to the cable C2.

(6) In FIG. 6, a shield case 40 is attached over the housing 21. The shield case 40 extends rearwardly from the housing 21 and covers the arranging block member 10 and the movable member 30. The shield case 40 comprises a securing piece 41 at a position corresponding to the exposed shield wire C1, which extends downwardly and has a sectional shape of reverse-U. The securing piece 41 secures the shield wire to hold the cable C.

(7) Finally, a cover 42 is attached outside the shield case 40.

The invention is not limited to the embodiment illustrated in FIGS. 1-6. For example, if a cable of a different diameter or different kind is mixed into ordinary cables, a pressing pin may be used for it.

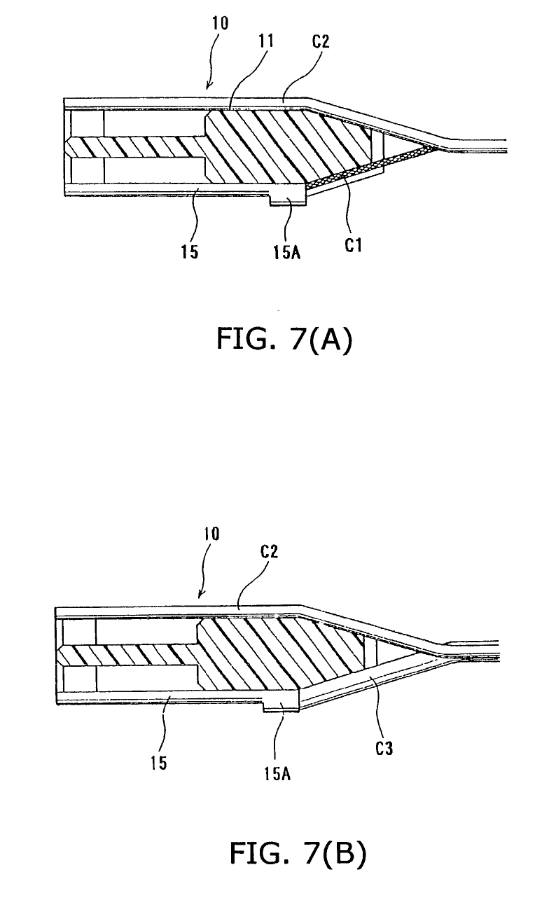

In FIG. 7(A), the ordinary cable C2 is accommodated in the upper cable aperture 11 and the shield wire C1 having a diameter smaller than the aperture width of the lower cable aperture 11 is accommodated in the lower cable aperture 11. After the shield wire C1 is connected to the pressing member 15 having a size corresponding to the aperture width of the cable aperture 11, the shield wire is accommodated in the guiding aperture 14 and the pressing pin is accommodated in the cable aperture 11. The shield wire C1 has a play in the guiding aperture 14 but it is no problem because the pressing pin 15 is closely pressed-held in the cable aperture 11. In FIG. 7(A), the shield wire C1 is press-connected to the pressing pin 15 by a press portion 15A but soldering connection may be used.

In FIG. 7(B) shows a cable C3 having a diameter larger than the aperture width of the cable aperture 11 is accommodated in the lower cable aperture 11. If the guiding aperture 14 has a width larger than that of the cable aperture 11, the cable C3 is accommodated therein and the pressing pin 15 having a diameter corresponding to the width of the cable aperture 11 is accommodated in the cable aperture 11. The pressing pin 15 and the cable C3 are press-connected or solder-connected with each other. For the above reason, it is preferable that the guiding aperture has the width lager than that of the cable aperture 11.

Also, it is preferable that the deep aperture portion of the arranging block member 10 be inserted into the housing 21 up to a position deeper than the position of the contact portions 27A of the terminal 22.

The movable member 30 may be rotatably supported by the housing 21 instead of the terminal 22.

As has been described above, according to the invention, since the cable is held in the cable aperture at the position corresponding to the contact portion of the terminal, the cable does not come off the cable aperture but is firmly press-connected to the contact portion of the terminal when the movable member is rotated to the closed position, thus increasing the reliability in connection between the terminal and the cable. In addition, the cable is arranged in the cable aperture of the arranging block member before the arranging block member is plugged in the housing, thereby to improve the manufacturing efficiency.

1. An electrical connector for press-connection with a plurality cables, comprising:
a housing having an opening and a receiving portion provided in said opening;
a plurality of terminals arranged in said housing at a fixed interval, each having a flexible arm with a contact portion projecting through said receiving portion in said opening;
a movable member movably supported by said housing or said terminals at said opening; and
an arranging block member plugged in said receiving portion of said housing and having a plurality of cable apertures for accommodating said cables such that each cable is disposed at a position corresponding to a position of said contact portion, said cable aperture permitting said flexible arm to enter a lower part of said cable aperture so that said cable in said cable aperture is press-connected with said contact portion of said flexible arm by said movable member when said movable member is turned to a predetermined position.

2. The electrical connector according to claim 1, wherein said movable member is rotatably supported by said housing or said terminals and said cable is press-connected with said contact portion when said movable member is turned to a closed position.

3. The electrical connector according to claim 1, wherein said cable apertures extend up to a position deeper than said position of said contact portions.

4. The electrical connector according to claim 1, wherein said arranging block member comprises a plurality of guiding apertures provided on the opposite side of said housing and communicates with said cable apertures.

5. The electrical connector according to claim 4, wherein each of said guiding apertures has an aperture width equal to or larger than that of said cable apertures.

6. The electrical connector according to one of claim 1, wherein each of said cable apertures has a deep aperture portion on the side of said housing and a shallow aperture portion on the opposite side of said housing so that said flexible arm of said terminal enters a lower part of said deep aperture portion.

7. The electrical connector according to claim 1, wherein said cable apertures are provided on both sides of said arranging block member, and said movable member and said terminals are provided on both sides of said housing.

8. The electrical connector according to claim 7, wherein said arranging block member has a portion tapered in a thichnesswise direction thereof in the range of said guiding apertures.
